(19) United States
(12) Patent Application Publication
(10) Pub. No.: US 2014/0226354 A1
(43) Pub. Date: Aug. 14, 2014

(54) OPTICAL SYSTEM FOR AN ILLUMINATION DEVICE FOR VEHICLES

(71) Applicant: HELLA KGaA, Lippstadt (DE)

(72) Inventor: Martin Mügge, Geseke (DE)

(73) Assignee: HELLA KGaA, Lippstadt (DE)

(21) Appl. No.: 14/176,859

(22) Filed: Feb. 10, 2014

(30) Foreign Application Priority Data
Feb. 12, 2013 (DE) 102013101344.9

(51) Int. Cl. F21S 8/10

(52) U.S. Cl. CPC F21S 48/24
USPC 362/511

(57) ABSTRACT

An optical system for an illumination device for vehicles includes at least one light unit for generating a lighting function, semi-transparent mirrored surfaces, and reflective mirrored surfaces, characterized in that the reflective mirrored surfaces and the semi-transparent mirrored surfaces are oriented in the direction of a main direction of emission such that the sub light beam emitted by the light guiding element can be guided in the direction of the main direction of emission.

### CROSS REFERENCE

This application claims priority to German Patent Application No. 10 2013 101344.9, filed Feb. 12, 2013.

### TECHNICAL FIELD OF THE INVENTION

The invention relates to an optical system for an illumination device for vehicles, comprising at least one light unit for generating a lighting function, semi-transparent mirrored surfaces, and reflective mirrored surfaces.

### BACKGROUND OF THE INVENTION

From EP 2390137 A1, an illumination device for vehicles is known in which the emitted light can be guided against and in the direction of a main direction of emission with a light-emitting light source and with an optical unit allocated to the light source. The optical unit has a mirror device with a front mirror and a mirror arranged behind the front mirror in the main direction of emission. The light can be reflected back and forth between these mirrors. Here, the front mirror has a semi-transparent design so that a first part of the light beam incident on the front mirror passes through in the main direction of emission and a second part of the light beam incident on the front mirror is reflected in the direction of the rear mirror. The mirror device formed in this way acts as a “mirror tunnel” for generating a “tunnel light” that enables an appearance of the illumination device with a depth effect.

From DE 10 2010 006 348 A1, an illumination device for vehicles is known in which a first light unit and at least one second light unit arranged behind the first light unit in the main direction of emission are arranged in a housing, wherein the first light unit has a two-dimensional light guiding element with a rear side facing the second light unit, a front side facing away from the second light unit, and a narrow side connecting the rear side to the front side, with at least one light element being allocated as a light coupling surface to the narrow side for coupling the light into the two-dimensional light guiding element. The rear side and/or the front side of the two-dimensional light guiding element are provided with a number of decoupling elements, so that a light beam with a specified light intensity distribution can be emitted from the front side of the two-dimensional light guiding element. Here, the at least second light unit has a two-dimensional light guiding element with the same decoupling elements arranged on a front side and/or on a rear side. In this way, in a space-saving design, the stylistic appearance is expanded without limiting the lighting function.

The problem of the present invention is to provide an alternative optical system for an illumination device for vehicles that can be provided in a housing in a space-saving, simple, and economical way and in which the illumination surface can be increased and optimized visibility at large angles of observation can be achieved with a simultaneously non-obvious configuration of the mirrors for achieving visible depth effects in the illumination.

### SUMMARY OF THE INVENTION

To solve this problem, reflective mirrored surfaces and the semi-transparent mirrored surfaces are oriented in the direction of a main direction of emission such that the sub light beams emitted by the light guiding element can be guided in the direction of the main direction of emission.

The special advantage of the invention consists in that, through the provision of several semi-transparent mirrored surfaces that are arranged around a light guiding element, sub light beams that are emitted by the light guiding element can be guided, deflected, and reflected in different directions, in order to increase the illumination surface and to achieve optimized visibility at large angles of observation, with a simultaneously nested configuration of the mirrors for achieving visible depth effects in the illumination.

Here, the semi-transparent mirrored surfaces are arranged between the light guiding element and the reflective mirrored surface. The sub light beam emitted by the light guiding element is reflected and deflected in the light guiding system such that a depth effect is produced, wherein this effect can also be achieved in very small optical systems.

Here, the design according to the invention can provide a solution that also offers multiple stylistic possibilities for a wide range of different shapes, so that the vehicle manufacturer can use different systems that are designed independent from each other.

According to one preferred embodiment of the invention, the half mirror is generated by a partial vapor phase deposition or sputtering of the surface of a transparent plastic element. In this way, the layer thickness of the sputtering and the material used for the sputtering (aluminum, chromium, stainless steel, silver, gold, etc.) can be varied in order to achieve different appearances and degrees of reflection or transmission.

Furthermore, the side surfaces of the light guiding element can be provided with decoupling structures that image an arbitrary graphic, e.g., points, lines, or graphical elements, and refract incident light internally and output it to the sides. The decoupling structures can be constructed here as eroded, etched, or lasered structures or as printed or optical elements.

The light emitted by the light conductor is guided (reflected and refracted) according to the invention by a system of half mirrors and full mirrors in order to increase the illuminated surface and deflect light also up to large lateral angles of observation. The surface area must be increased, in order to achieve, e.g., the illuminated area of 50 cm² required for USA approval in the forward projection, even if only a single small optical system is used. Due to the increasing luminous fluxes of LEDs available today, it is no problem to generate the luminous intensities of each function with very small optical systems; the difficulty, however, lies in also meeting the surface area requirement.

The number of reflective mirrored surfaces and that of the semi-transparent mirrored surfaces can here be selected arbitrarily, in order to generate the desired light directions. In this way, the angle of the mirrored elements relative to each other or relative to the optical axis of the system can also be varied.

According to one refinement of the invention, the mirrors are positioned directly in front of the light outlet of the optical system. For this purpose it is significant to set a weak degree of reflection with the sputtering, in order to still produce enough light with a semi-transparent mirror or to select a full mirror, in order to guide all of the light of the optical system to the sides and to reflect it back in the direction of the light outlet at a different point.

According to one refinement of the invention, the individual half mirrors that are made from a transparent plastic are illuminated from above or below with additional LED light sources that are thus used themselves actively as light guiding elements.

According to one refinement of the invention, the mirrored elements can be provided as individual elements or can also be produced integrally as a coherent additional lens. This depends on the respective configuration of the function and the size of the functional chamber.

The mirrored elements form a three-dimensional structure in that they are arranged at angles to each other and in different sizes, positions, and depths relative to the optical system. This arrangement also produces a three-dimensional impression of the illuminating function for the viewer, because the light reflections are perceived to come from different surfaces.

For a classical reflector configuration with the light source at the focal point of a parabolic reflector, the viewer perceives, in contrast, the entire reflector surface as a whole as the illuminating surface, which produces no depth effect.

According to one refinement of the invention, the optical system can also be a two-dimensional system, e.g., a reflector matrix or a Fresnel lens matrix or a light conductor that extends behind the mirrored elements (transverse to these elements) and the light is output over a surface area in the direction of the light outlet. This light can be received by the mirrored elements and distributed accordingly.

These aspects are merely illustrative of the innumerable aspects associated with the present invention and should not be deemed as limiting in any manner. These and other aspects, features and advantages of the present invention will become apparent from the following detailed description when taken in conjunction with the referenced drawings.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1 a schematic diagram of a light guiding element,

FIG. 2 a top view of a light guiding system,

FIG. 3 a bird's eye view of the light guiding system according to FIG. 2,

FIG. 4 a top view of an alternative light guiding system,

FIG. 5 a bird's eye view of the light guiding system according to FIG. 4,

FIG. 6 a top view of another alternative light guiding system,

FIG. 7 a bird's eye view of the light guiding system according to FIG. 6,

FIG. 8 a top view of another alternative light guiding system, and

FIG. 9 a bird's eye view of the light guiding system according to FIG. 8.

### DETAILED DESCRIPTION

In the following detailed description numerous specific details are set forth in order to provide a thorough understanding of the invention. However, it will be understood by those skilled in the art that the present invention may be practiced without these specific details. For example, the invention is not limited in scope to the particular type of industry application depicted in the figures. In other instances, well-known methods, procedures, and components have not been described in detail so as not to obscure the present invention.

An optical system according to the invention for signal functions can be arranged in a rear tail lamp, a head lamp, or general illumination lights.

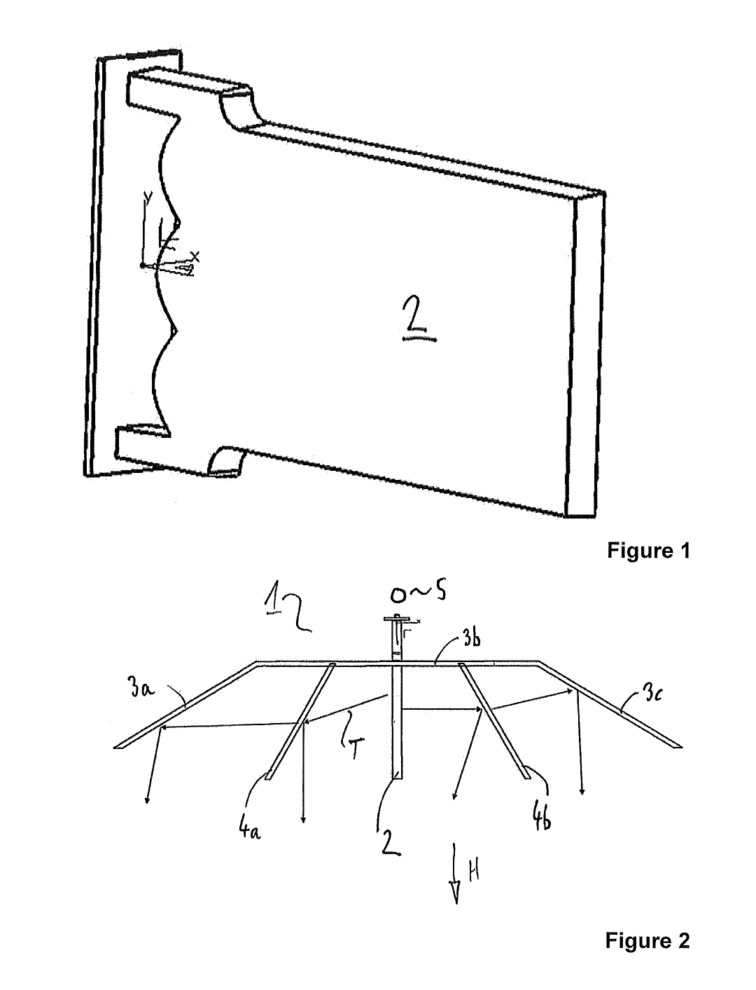

FIG. 1 shows a schematic diagram of a light guiding element. The present device involves a two-dimensional light guiding element (edge light) that can be preferably integrated vertically and centrally in the optical system.

Light is fed into the light guiding element 2 on the rear side from a light source 5 (FIG. 2). The light passes through the light guiding element 2 according to the principle of total reflection at the respective boundary surfaces and is then output at the front edge. For controlling the light, the front edge can have scattering optics in the form of pillow optics, strip optics, or prism optics.

In addition, light is also output from the two side surfaces of the light guiding element 2.

FIG. 2 shows a top view of a light guiding element. The optical system (light guiding system) 1 has, in addition to the light guiding element 2 and the light element 5, a reflective mirrored surface 3 and two semi-transparent mirrored surfaces 4a-4b.

The reflective mirrored surface 3 has three sub-areas 3a-3c, wherein the sub-area 3b is between the sub-areas 3a and 3c and holds the light guiding element 2 in the middle.

The semi-transparent mirrored surfaces 4a-4b are connected to the reflective mirrored surface 3 on the sub-area 3b. The free ends of the mirrored surfaces 4a and 4b are inclined relative to the light guiding element arranged in the middle. The free ends of the sub-areas 3a and 3c are inclined even more greatly relative to the light guiding element 2 arranged in the middle.

In the top view from FIG. 2, beam paths are shown in order, on one hand, to show their course and, on the other hand, to make it clear that the two lenses 4a and 4b, as semi-transparent lenses, both reflect and also refract light. The sub light beam T is shown as an example.

All of the sub light beams T are deflected/reflected until they emerge from the light guiding system 1 in the direction of the main emission H.

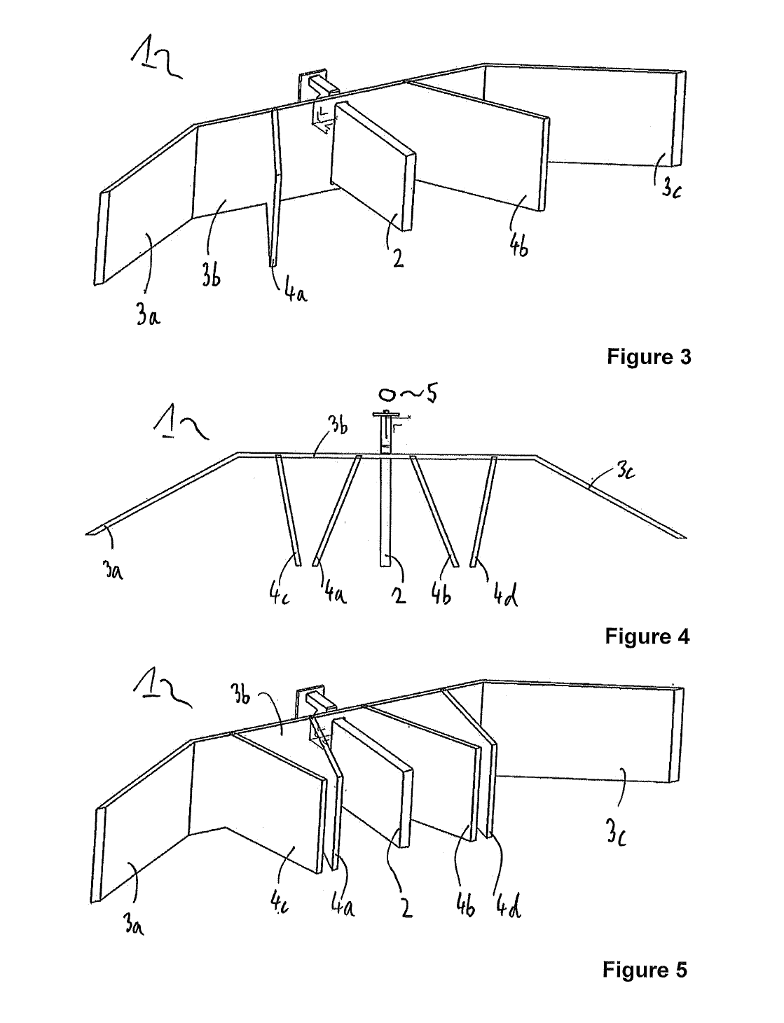

FIG. 3 shows a bird's eye view of the light guiding system according to FIG. 2.

FIG. 4 shows a top view of an alternative light guiding element. The optical system (light guiding system) 1 has, in addition to the light guiding element 2 and the light element 5, a reflective mirrored surface 3 and four semi-transparent mirrored surfaces 4a-4d.

The reflective mirrored surface 3 has three sub-areas 3a-3c, wherein the sub-area 3b is between the sub-areas 3a and 3c and holds the light guiding element 2 in the middle.

The semi-transparent mirrored surfaces 4a-4d are connected to the reflective mirrored surface 3 on the sub-area 3b. The free ends of the mirrored surfaces 4a-4d are inclined to the left and right, respectively, relative to the light guiding element arranged in the middle. The free ends of the sub-areas 3a and 3c are more greatly inclined relative to the light guiding element arranged in the middle.

FIG. 5 shows a bird's eye view of the light guiding system according to FIG. 4.

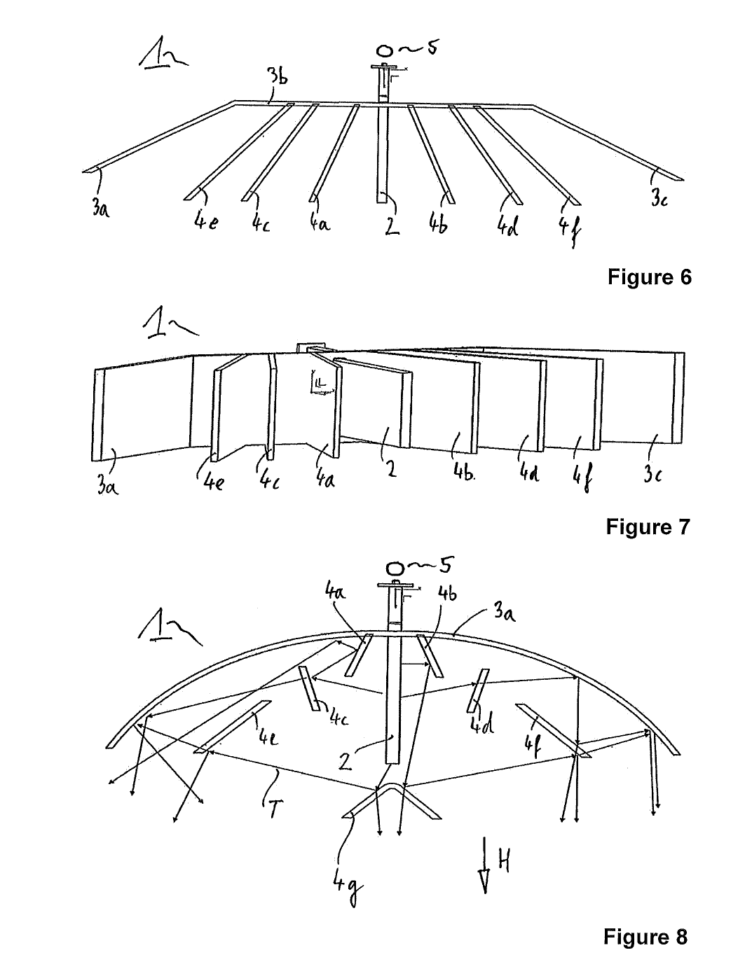

FIG. 6 shows a top view of another alternative light guiding element. The light guiding system 1 has, in addition to the light guiding element 2 and the light element 5, a reflective mirrored surface 3 and six semi-transparent mirrored surfaces 4a-4f.

The reflective mirrored surface 3 has three sub-areas 3a-3c, wherein the sub-area 3b is between the sub-areas 3a and 3c and holds the light guiding element 2 in the middle.

The semi-transparent mirrored surfaces 4a-4f are connected to the reflective mirrored surface 3 on the sub-area 3b. The free ends of the mirrored surfaces 4a-4f are inclined relative to the light guiding element arranged in the middle. The free ends of the sub-areas 3a and 3c are even more greatly inclined relative to the light guiding element arranged in the middle.

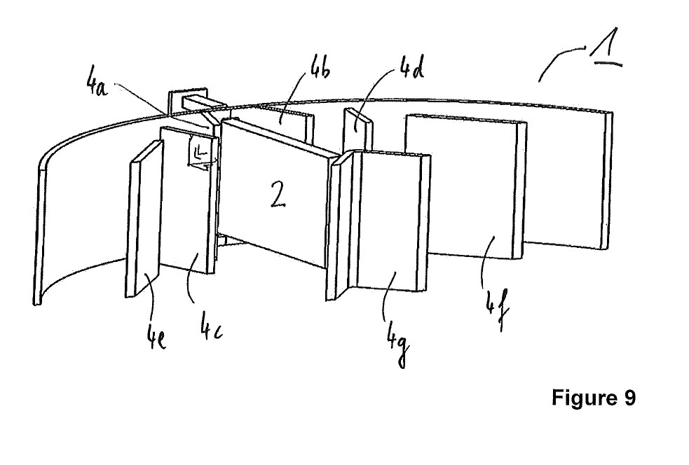

FIG. 7 shows a bird's eye view of the light guiding system according to FIG. 6. FIG. 8 shows a top view of another alternative light guiding element. The light guiding system 1 has, in addition to the light guiding element 2 and the light element 5, a reflective mirrored surface 3 and seven semi-transparent mirrored surfaces 4a-4g.

The reflective mirrored surface 3 is a semicircular domed mirrored surface that holds the light guiding element 2 in the middle.

The semi-transparent mirrored surfaces 4a-4b are connected to the reflective mirrored surface 3 in the area of the light guiding element 2. The free ends of the mirrored surfaces 4a-4b are inclined relative to the light guiding element 2 arranged in the middle. The semi-transparent mirrored surfaces 4c-4f are arranged in the light guiding system 1 corresponding to FIG. 8. The tips of the mirrored surface 4g with its V-shaped cross section is located here in front of the end side of the light guiding element 2.

In the top view from FIG. 8, beam paths are shown in order, on one hand, to show their course and, on the other hand, to make it clear that the lenses 4a-4g, as semi-transparent lenses, both reflect and also refract light. The sub light beam T is shown as an example.

All of the sub light beams T are deflected/reflected until they emerge from the optical system in the direction of the main emission H.

FIG. 9 shows a bird's eye view of the light guiding system according to FIG. 8.

The preferred embodiments of the invention have been described above to explain the principles of the invention and its practical application to thereby enable others skilled in the art to utilize the invention in the best mode known to the inventors. However, as various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by the above-described exemplary embodiment, but should be defined only in accordance with the following claims appended hereto and their equivalents.

### LIST OF REFERENCE SYMBOLS

1 Optical system
2 Light guiding element
3, 3a-3c Reflective mirrored surface
4a-4g Semi-transparent mirrored surface
5 Light element
T Sub light beam
H Main direction of emission

1. An optical system for an illumination device for vehicles, comprising:
at least one light unit for generating a lighting function and further comprising semi-transparent mirrored surfaces and reflective mirrored surfaces and a light guiding element that emits a sub light beam,
wherein the reflective mirrored surfaces and the semi-transparent mirrored surfaces are oriented in the direction of a main direction of emission such that the sub light beam emitted by the light guiding element can be guided in the direction of the main direction of emission.

2. The optical system according to claim 1, wherein the semi-transparent mirrored surfaces are arranged in the optical system such that the sub light beams that are emitted by the light unit and are not reflected by the semi-transparent mirrored surfaces are totally reflected by the reflective mirrored surfaces.

3. The optical system according to claim 1, wherein at least some of the semi-transparent mirrored surfaces are arranged approximately parallel to the light unit.

4. The optical system according to claim 1, wherein the reflective mirrored surfaces are vapor phase deposited plastic elements, preferably an additional lens, a screen, or a housing, and the semi-transparent mirrored surfaces are vapor phase deposited plastic elements that can be generated at least in partial areas by partial vapor phase deposition or sputtering of the surface.

5. The optical system according to claim 1, wherein the light guiding element has a rod-shaped, strip-shaped, or two-dimensional construction and/or has at least one light element, preferably an incandescent lamp or an LED light source.

6. The optical system according to claim 1, wherein the mirrored surfaces of the semi-transparent and reflective mirrored surfaces are planar, bulged, or faceted by different prismatic surfaces.

7. The optical system according to claim 1, wherein the mirrored surfaces of the semi-transparent and reflective mirrors are individual elements that can be joined together or are constructed as individual pieces.

8. The optical system according to claim 1, wherein the semi-transparent mirrored surface can be positioned directly in front of the light outlet of the optical system.

9. The optical system according to claim 1, wherein the optical system is a two-dimensional system, preferably a reflector matrix, a Fresnel lens matrix, or a light conductor.

10. The optical system according to claim 1, wherein additional LED light sources are provided and the semi-transparent mirrors can be illuminated from above and also from below.
